(19) United States
(12) Patent Application Publication
(10) Pub. No.: US 2015/0100432 A1
(43) Pub. Date: Apr. 9, 2015

(54) USING SEMANTIC ANALYSIS TO ENHANCE PERSONALIZED DOCUMENTS IN A VARIABLE DATA MARKETING CAMPAIGN

(71) Applicant: Xerox Corporation, Norwalk, CT (US)

(72) Inventor: Michael David Shepherd, Ontario, NY (US)

(73) Assignee: Xerox Corporation, Norwalk, CT (US)

(21) Appl. No.: 14/048,622

(22) Filed: Oct. 8, 2013

(51) Int. Cl. G06Q 30/02

(52) U.S. Cl. CPC G06Q 30/0271
USPC 705/14.67

(57) ABSTRACT

A system generates variable data documents, such as those that may be used in a marketing campaign, each of which contains content that is selected specifically for the document's recipient. The system uses a document template that includes dynamic element fields. Some of the dynamic element fields will be populated with personalized data such as the recipient's name, a geographic indicator, a date, or other information. Other data element fields will be populated with reference locators that dynamically identify and point to additional digital content that is semantically relevant to one or more of the personalized data elements. The reference locator may point to a repository of content such as audiovisual media assets, surveys, product reviews, wikis, recipes or other content.

### BACKGROUND

Advertisers increasingly seek to target advertisements that are customized to the individual consumer. Such personalized ads may include messages created specifically for the consumer in an effort to offer the consumer products or services that he or she is likely to want or need. The ad will include data fields that are varied based on the individual consumer to which the ad is directed. Personalized ads may be in the form of e-mails, text messages, or web pages that may be delivered to electronic devices such as laptops, tablets and mobile phones.

A personalized marketing campaign requires significant effort by a logic developer to define the business rules for personalizing each document presented to the consumer in the campaign. There is a strong correlation between the marketer's desired variety of the personalization and the complexity and expense that is needed to create the logic for the campaign. It is possible to finely personalize the dynamic documents through the use of large repositories of data, but this effort comes with a high cost in current methods and systems. Because of this, personalized marketing campaigns will usually resort to using a small set of imagery and messaging for the variation in the personalized messages.

This document describes methods and systems that may enhance personalized marketing campaigns beyond rule-based personalization with plan logic (such as the QLingo language in the XMPie uPlan product) that include documents having data that is varied based on the consumer to which the document is targeted.

### SUMMARY

In an embodiment, a system includes one or more processors and a non-transitory, computer-readable medium that contains programming instructions for causing the processor(s) to generate variable data documents. The system identifies a variable data document template so that the variable data document template includes one or more static element fields and one or more dynamic element fields. For one or more of the dynamic element fields, the system receives an automated personalization task that corresponds to one or more semantic queries for (i) associating dynamic data with the dynamic element field, and (ii) associating the semantic queries to the dynamic element field. The system identifies a set of document recipients. For each recipient, the system generates a personalized document template by adding static data to at least one of the static element fields, identifies a set of candidate data to be populated in one or more of the dynamic element fields, and associates a personalized reference locator at which the recipient may retrieve a personalized variable data document in accordance with the recipient's personalized template.

When the system receives, from any recipient, a request that includes the personalized reference locator, it generates the recipient's personalized variable data document in accordance with the recipient's personalized document template. It may do this by including, in at least one of the dynamic element fields, personalized data corresponding to the recipient. For at least one of the dynamic element fields, the system may implement the semantic query (or queries) for that field to select dynamic data from the set of candidate data for the recipient, and it may include indicia of the selected dynamic data in the dynamic element field.

Optionally, when generating the personalized template for any recipient, the system may identify a data category for a first of the dynamic element fields of the recipient's personalized template. Data categories may include, for example, a recipient name, a geographic descriptor, a recipient area of interest, a mobile electronic device identifier, or any number of other categories. Based on the data category, it may annotate the first dynamic element field with a semantic annotation that includes a reference locator which corresponds to a content source that is semantically associated with the data category. It may also require that the content source be semantically associated with at least some of the personalized data for that recipient. The system may use content source to retrieve the candidate data to be included in the first dynamic element fields.

Optionally, when generating the recipient's personalized variable data document by implementing the semantic queries for the dynamic element fields to select dynamic data from the set of candidate data, the system may query the set of candidate data using a semantic query technique to return one or more attribute-value pairs, and it may use a semantic reasoning technique to identify one of the attribute-value pairs that is relevant to at least some of the personalized data for that recipient. In such a case, when including indicia of the selected dynamic data in a dynamic element field, the system may populate the dynamic element field with data corresponding to the identified attribute-value pair.

Optionally, when selecting the semantic annotation and annotating the first dynamic element field with the selected semantic annotation, the system may select, from the set of candidate data, an audiovisual media asset that is semantically associated with the data category, and it may identify a location of the selected audiovisual media asset. If so, then it may set the reference locator of the semantic annotation to include a reference locator that, when selected, causes access of the selected audiovisual media asset to be served from the location.

Alternatively, when selecting the semantic annotation and annotating the first dynamic element field with the selected semantic annotation, the system may select, from the set of candidate data, a survey or product review that is semantically associated with the data category, and it may identify a location of the selected survey or product review. If so, then it may set the reference locator of the semantic annotation to include a reference locator that, when selected, causes access of the selected survey or product review to be served from the location.

Alternatively, when selecting the semantic annotation and annotating the first dynamic element field with the selected semantic annotation, the system may select, from the set of candidate data, a wiki or recipe that is semantically associated with the data category, and it may identify a location of the selected wiki or recipe. If so, then it may set the reference locator of the semantic annotation to include be a reference locator that, when selected, causes access of the selected wiki or recipe to be served from the location.

In an alternative embodiment, a system that includes one or more processing devices may implement a method of generating a variable data document by identifying a variable data document template having one or more static element fields and one or more dynamic element fields. The system may select a first one of the dynamic element fields, and it may associate a semantic query with the selected dynamic element field. The semantic query defines an action for associating dynamic data with the dynamic element field. The system may then identify a recipient and generate a personalized document template for the recipient by identifying a set of candidate data to be populated in one or more of the dynamic element fields and associating a personalized reference locator at which the recipient may retrieve a personalized variable data document in accordance with the recipient's personalized template. When the system receives a request that includes the personalized reference locator, then in response the system may generate a personalized variable data document in accordance with the personalized document template by implementing the semantic query to select dynamic data from the set of candidate data, and including indicia of the selected dynamic data in the selected dynamic element field.

Optionally, in this embodiment, when generating the personalized document template the system may identify a data category and annotate the first dynamic element field with a semantic annotation that includes a reference locator which corresponds to a content source that is semantically associated with the data category, at least some of the personalized data for that recipient, or both. If so, when identifying the set of candidate data the system may identify a set of candidate data that is available at the content source.

Optionally, implementing the semantic query to select dynamic data from the set of candidate data may include querying the set of candidate data using a semantic query technique to return a plurality of attribute-value pairs, and using a semantic reasoning technique to identify one of the attribute-value pairs that is relevant to at least some of the personalized data for that recipient. With this option, including indicia of the selected dynamic data in the dynamic element field may include comprises populating the dynamic element field with data corresponding to the identified attribute-value pair.

Optionally, annotating the dynamic element field with the semantic annotation may include selecting, from the set of candidate data, an audiovisual media asset, survey, product review, wiki, recipe or other asset that its semantically associated with the data category, identifying a location of the selected asset, and setting the reference locator of the semantic annotation to include a reference locator that, when selected, causes access of the selected asset to be served from the location Alternatively, the system may automatically perform a web search for a result that is relevant to the data category, at least some of the personalized data for that recipient, or both. If so, then the system may set the reference locator of the semantic annotation to include a reference locator that corresponds to the result.

### BRIEF DESCRIPTION OF THE DRAWINGS

FIG. 1 is a flowchart illustrating a method of generating and providing a personalized document.

FIG. 2 illustrates an example of a template for a personalized document.

FIG. 3 illustrates examples of hardware that can be used to implement various elements described in this document.

### DETAILED DESCRIPTION

As used in this document, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” means “including, but not limited to.”

As used in this document, the term “variable data document” refers to an electronic file (or group of files) that contains data that can be used to generate a presentation to an actual or potential consumer, where at least some of the data in the document is specifically selected for the consumer to whom the presentation is presented. The variable data will be displayed on the electronic or physical representation of the presentation. The presentation may be a web page or other document that is accessed via a communications network using an address at which the consumer may reach the document.

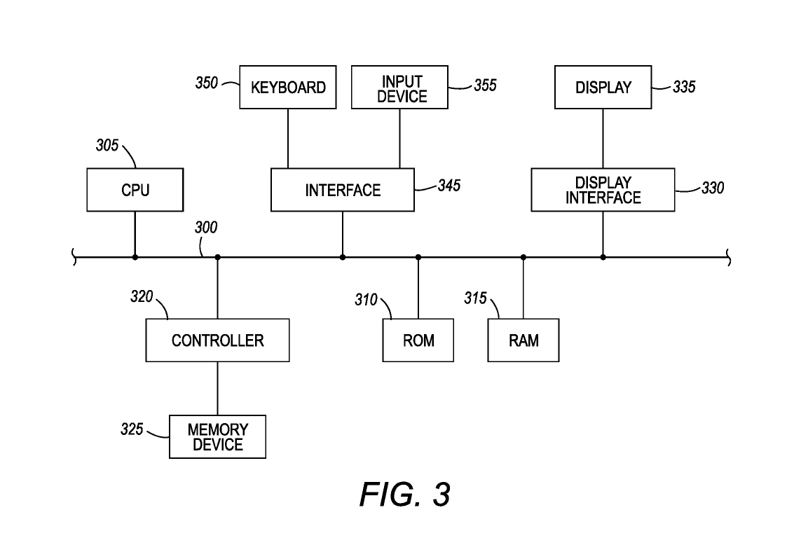

In this document, an “electronic device” refers to a device that includes a processor and tangible, computer-readable memory. The memory may contain programming instructions in the form of a software application that, when executed by the processor, causes the device to perform various operations according to the programming instructions. Examples of suitable devices include portable electronic devices such as smart phones, personal digital assistants, cameras, tablet devices, electronic readers, personal computers, media players, satellite navigation devices and the like. Example components of an electronic device are discussed below in reference to FIG. 3.

In this document, a “reference locator” refers to an address or other character string that defines a location at which a user may access a variable data document. Examples of location elements include uniform reference locators (URLs), other uniform reference identifiers and Internet Protocol (IP) addresses. A “personalized” reference locator is a reference locator that is associated a location at which a user may retrieve a customized and/or personalized document that includes content that was specifically selected for the user.

In this document, the term “semantic reasoning” means using programming logic that takes one or more input terms and identifies a result based on the meaning of the input terms. Examples of semantic reasoning applications include those that use the W3C's Web Ontology Language (OWL), the SPARQL Query Language, or the Protocol for Web Description Resources (POWDER). In addition, a “semantic annotation” refers to an annotation that includes content that is related to the meaning of one or more reference words or phrases. Further, a “semantic query” is a structured query made up of one or more terms that is used to perform a semantic search to retrieve a number of results that are relevant to the query's intent. Semantic search improves search accuracy through the use of knowledge expressed with common business vocabulary.

The creation of a personalized (i.e., variable data) marketing document in a marketing campaign requires both a recipient list and plan logic. The recipient list includes raw data about who will receive personalized versions of the marketing document. The plan logic includes the rules that, upon examination of the recipient data, may be used to determine how to personalize the document. Each personalized item in the document may be called a dynamic element. The value of each dynamic element may come directly from the recipient data, may be determined via the logic in the plan, or may be determined based on both recipient data and plan logic. A dynamic element may include various components, such as a personalized data component which remains static after the personalized data is added, as well as a reference locator component which dynamically retrieves data when each instance of the document is displayed or otherwise presented.

Across all documents in a marketing campaign, a particular dynamic element's value may come from a large set of possible values. For instance, a recipient list may contain each recipient's name or other personal identifier (such as an email address); a geographic identifier such as an address, city, state and/or country; and one or more areas of interest for the recipient such as a hobby, athletic activity or school affiliation. Although not necessarily unique to each recipient, these data categories may include a wide range of values. Similarly, a plan may include logic that uses a recipient's data to identify a particular demographic of the recipient, which is then used to determine the value of a dynamic element to be added to the personalized document for the recipient. For example, in a marketing document for a travel agency or hotel chain, a recommended vacation destination may be a dynamic element. The system may identify the destination based on the recipient's typical vacation spending, hobbies/interests, previous vacation locations, preferred methods of travel or other relevant personal data.

When the dynamic document is a web page, a software application may build the personalized page and assign a personalized reference locator to the page. An example of such a personalized reference locator is a personalized URL, which is a URL that links to a web page specifically designed for a particular recipient. Example code for a web page associated with a personalized URL source may include code such as:

```
  <td class=“pageTitle”><br /><br />Thank you!<br /><br
/></td>
  <td class=“text”>Harry, we are so excited that you are
interested in joining us! Don't forget to pick up your free Acme
Corp. music player when you arrive to the open house.<br />
  <b>We look forward to seeing you in Oslo Norway on Nov.
26</b>!
```

### EXAMPLE 1

In Example 1 above, the document is personalized with personalized data corresponding to the recipient, including the recipient's name (Harry), a product (Acme Corp. music player), a geographic location (Oslo, Norway) and a date (November 26).

(NOTE: For ease of reading, only selected portions of the example code are included in the examples of this document. Formatting elements such as <table> tags, <tr> tags and <td> tags are omitted from this and other examples for clarity.)

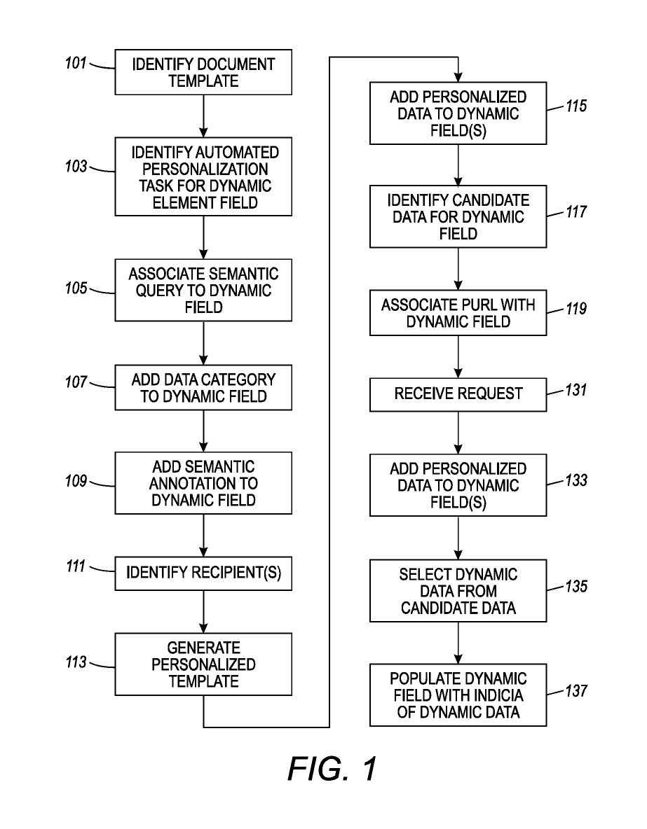

A method by which a system may create a variable data document is illustrated in the flowchart of FIG. 1. In FIG. 1, the system identifies a variable data document template so that the variable data document template 101 includes one or more static data element fields and one or more dynamic element fields. Such a template may be pre-existing, and Example 1 above illustrates a portion of such a template, which may have been created using methods such as those described in United States Patent Application Pub. No. 2002/0049702 titled “System and method for creating customized documents for cross media publishing.”

In accordance with a system as proposed in this disclosure, the static data element fields may be populated with certain data that is presented to all recipients. For each of the dynamic element fields, the system may be assigned and thus receive an automated personalization task 103. Each automated personalization task corresponds to (by including or pointing to) one or more semantic queries for associating dynamic data with the dynamic element field. The system associates the semantic queries to the dynamic element field 105.

Each dynamic element also may be assigned a data category 107 which adds semantic identification of the dynamic element. This may occur manually, such as by receipt of an assignment from a human operator. Alternatively, it may occur automatically, using methods such as those disclosed in U.S. Patent Application Pub. No. 2012/0046937, titled “Semantic Classification of Variable Data Campaign Information,” published Feb. 23, 2012, the disclosure of which is incorporated herein by reference in its entirety. This process may identify certain data elements as eligible for semantic markup. Example 2 shows this by taking the text of Example 1 and replacing elements of personalized data with data categories (replacements are shown in bold font for illustration purposes):

```
  <td class=“pageTitle”><br /><br />Thank you!<br /><br
/></td>
  <td class=“text”>{{First Name}}, we are so excited that you
are interested in joining us! Don't forget to pick up your free
{{Product}}when you arrive to the open house.<br />
  <b>We look forward to seeing you in {{City}},
{{Region/State}}on {{Event Date}}</b>!
```

### EXAMPLE 2

Data categories may be any suitable category, such as the categories of a recipient name, geographic descriptor (e.g., address, city, state or country), a recipient area of interest, or mobile electronic device model identifier.

Based on the data category for any dynamic element field, the system may annotate the first dynamic element field with a semantic annotation 109 that includes a reference locator which corresponds to a content source that is semantically associated with the data category. The content source may be one which the system semantically associates with at least some of the personalized data for the recipient of the document. The system may also identify a set of recipients 111. For each recipient, the system may generate a personalized template 113, add personalized data corresponding to the recipient to at least one of the dynamic element fields 115, identify a set of candidate data to be populated in one or more of the dynamic element fields 117, and associate a personalized reference locator at which the recipient may retrieve a personalized variable data document in accordance with the recipient's personalized template 119. Example 3 shows how this may be accomplished by taking the text of Example 2, returning the personalized data elements and replacing the data categories with semantic annotations for the recipient of Example 1:

```
<td class=“pageTitle”><br /><br />Thank you!<br /><br /></td>
<td class=“text”>
  <section itemscope itemtype=“http://schema.org/Person”>
      <span itemprop=“name”>Harry</span>
  </section>
, we are so excited that you are interested in joining us! Don't
forget to pick up your free
    <section itemscope itemtype=“http://schema.org/Product”
  itemid=“#giveaway”>
        <span itemprop=“brand”>Acme Corp</span>
        <span itemprop=“name”>music player</span>
  </section>
  when you arrive to the open house.<br />
  <b>We look forward to seeing you in
      <section itemscope Itemtype=
  “http://schema.org/Address”>
        <span itemprop=“city”>Oslo</span>,
        <span itemprop=“region”>Norway</span>
      </section>
  on Nov. 26</b>!
```

### EXAMPLE 3

As noted above, optionally, the semantic annotation may include a reference locator that corresponds to a content source that is semantically associated with the data category. If so, the system may access the set of candidate data, and an audiovisual media asset (e.g., an image, audio file or video file) that it identifies as being semantically associated with the data category. When the system identifies a location of the selected audiovisual media asset at a web address or other location, the system may set the reference locator of the semantic annotation to be a reference locator that, when selected, causes access of the selected audiovisual media asset to be served from the location.

In some embodiments, any dynamic element field may be associated with semantic queries that automatically modify its semantic annotation with additional personalization based on the personalized data contained within that field or within any of the dynamic data element fields. For example, when a dynamic element field contains a geographic descriptor such as an address, city, state, region or country, the system may recognize this and automatically perform a web search on that geographic descriptor and return a link (such as a uniform reference locator or other address) for the search result, or it may automatically identify a wiki containing information relevant to the geographic descriptor and return a link for the wiki. An example of this is shown in Example 4 below, where the link of Example 3 with the geographic descriptor of “Oslo” is automatically supplemented with semantically annotated content for a wiki associated with that city:

```
<section itemscope Itemtype= “http://schema.org/Address”>
  <span itemprop=“city”>
    <a href=“http://en.wikipedia.org/wiki/Oslo”>Oslo</a></span>,
  <span itemprop=“region”>Norway</span>
</section>
```

### EXAMPLE 4

Thus, the user of campaign creation software may specify that an automated personalization task in a personalized document (e.g., a web page) require that the address.city dynamic element be hot linked. The system may then automatically add HTML (such as that shown in bold in Example 4) or other relevant reference location information to the personalized document.

When the system receives a request that includes the personalized reference locator from any one of the recipients 131, it may generate the recipient's personalized variable data document in accordance with the recipient's personalized template. It may do this by adding personalized data corresponding to the recipient to at least one of the dynamic data element fields 133. Examples of such data may include the recipient's name, address, or other personalized data corresponding to that recipient. For one or more of the dynamic element fields, the system also may implement semantic queries for that field to select dynamic data from the set of candidate data for the page's recipient 135, and it may include indicia of the selected dynamic data in the relevant dynamic element field(s) 137. The indicia may be the data itself, or an indicator of where the data is available, such as a URL.

To select dynamic data from the set of candidate data, the system may perform any suitable process such as querying the set of candidate data using a semantic query technique to return one or more attribute-value pairs, using semantic techniques to identify one of the attribute-value pairs that is relevant to at least some of the personalized data for that recipient. The system may then populate the dynamic element field with data corresponding to the identified attribute-value pair. Examples of such methods are disclosed in, for example, U.S. Patent Application Pub. No. 2013/0054651, filed Aug. 23, 2011 by Shepherd et al., titled “Knowledge-Assisted Approach to Dynamically Create Data Sources for Variable-Data Marketing Campaigns,” the disclosure of which is incorporated herein by reference in its entirety.

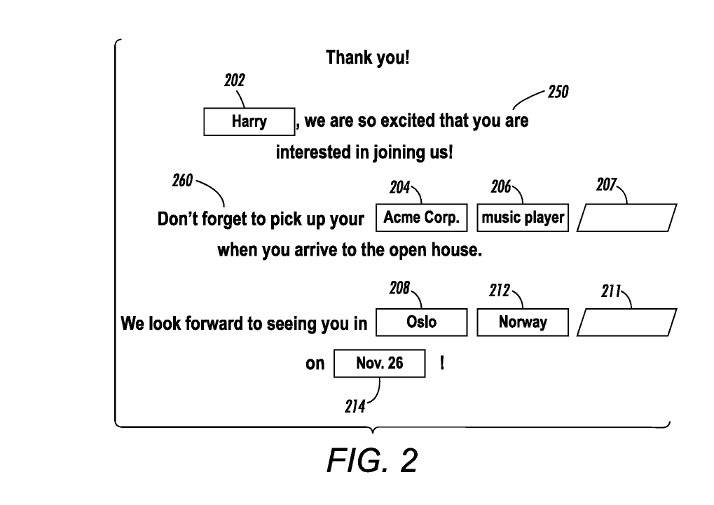

FIG. 2 illustrates an example of a personalized document (in this case, text to be displayed in a web page), with dynamic data element fields containing personalized data (represented by even numbers 202, 204, 206, 208, 212, and 214), dynamic data element fields containing a personalized reference locator (represented by odd numbers 207 and 211), and static data element fields (such as fields 250 and 260). As shown, the personalized data dynamic data element fields may include personalized data such as the recipient's name 202 and/or a product 204, 206, and/or a geographic identifier 208, 212 and/or a date 214. The reference locator dynamic data element fields 207 and 211 may be populated with data and/or reference locators that are semantically related to the data in the adjacent static element fields. For example, the dynamic element field 211 that is associated with the geographic identifier fields 208, 212 may be hotlinked with the URL of a wiki that is includes information relevant to the location that is in the geographic identifier fields(s). The static data element fields 250, 260 may include content that is presented to all recipients of the document.

Examples of reference locators may be those related to geographic identifiers (as shown), surveys or product reviews, wikis, recipes, or other information. For example, annotating a first dynamic element field with a semantic annotation that comprises a reference locator which corresponds to a content source that is semantically associated with the data category, the system selects geographic information, a wiki, a survey or a product review that is semantically associated with the data category. The system may identify a location of the selected item, and it may set the reference locator of the semantic annotation to be a reference locator that, when selected, causes access of the selected item to be served from the location.

Examples of content that may be identified for population in a dynamic element include semantically tagged images that are approved for use in a marketing campaign. The semantic personalization processing step could query the dynamic elements against a repository of digital content (images, videos, audio clips, etc.) and automatically include relevant digital content in the document. Example 5 below illustrates how this may occur in the context of Example 4 above for insertion of a digital image:

```
<section itemscope itemtype=“http://schema.org/Address”>
  <span itemprop=“city”>
    <ahref= http://en.wikipedia.org/wiki/Oslo”>Oslo</a></span>,
  <span itemprop=“region”>Norway</span>
  <img itemprop=“image” src=“oslo.jpg” alt=“location image”/>
</section>
```

### EXAMPLE 5

The system may be used in situations when there is a large variation in a dynamic element, such as a city, person's name, product, area of interest, so that the plan logic needed to determine every possible value of the dynamic element would be much too complex for a developer. Instead, the semantic queries for the automated personalization task may automatically add digital content for an “address.city” dynamic data element. Upon execution of the campaign, as each personalization task is executed the system may automatically add the relevant code (such as that shown in bold font) in the examples above to the personalized document.

The content repository may include a set of candidate audiovisual assets, such as image repository of logos for businesses, sports teams, government entities or other organizations. Here, a reference locator such as a schema.org ‘itemid’ attribute may be used to semantically link the content in different sections of the personalized document. For example, if the campaign is designed to add personalization for the recipient's place of employment, the personalization element may appear as:

```
<section itemscope itemtype=“http://schema.org/Person”>
  <span itemprop=“name”>Harry</span>
    , your employer
    <span itemprop=“worksFor” itemscope
itemtype=“http://schema.org/Organization” itemid=“CompanyName”>
      <span itemprop=“name”>CompanyName</span>
  </span>
  , has a special offer for you!
</section>
<section itemscope itemtype=“http://schema.org/Organization”
itemid=“CompanyName”>
    <img itemprop=“image” src=“” width=“250” height=“125”
border=“0”/>
</section>.
```

### EXAMPLE 6

The semantic personalization processing of the system may embed the company logo as shown in bold:

<section itemscope itemtype=“http://schema.org/Organization”
itemid=“CompanyName”>
<img itemprop=“image”
src=“file://servername/images/logo.jpg” width=“250” height=“125”
border=“0”/>
</section>

### EXAMPLE 7

Semantic queries can be used to retrieve and include personalized content from knowledge bases such as the Web of Linked Data (http://linkeddata.org/) or other locations. Example ways of data repositories to populate dynamic elements of personalized marketing campaign are illustrated in, for example, U.S. Patent Application Pub. No. 2013/0054651, which is incorporated by reference above.

The system may be used to create various types of personalized documents for marketing campaigns, such as documents with a recommended list of activities to offer a vacationer based on demographics, or a possible travel itinerary based on the traveler's home city and flight & hotel options. Such semantic queries could use online data sources to populate the semantic markup with personalized information.

FIG. 3 illustrates hardware of one or more electronic devices that may be used to implement various features described above. An electrical bus 300 serves as an information highway interconnecting the other illustrated components of the hardware. CPU 305 is a central processing unit of the system, performing calculations and logic operations required to execute a program. CPU 305, alone or in conjunction with one or more of the other elements disclosed in FIG. 3, is a processing device, computing device or processor as such terms are used within this disclosure. Read only memory (ROM) 310 and random access memory (RAM) 315 constitute examples of memory devices.

A controller 320 interfaces with one or more optional memory devices 325 that service as date storage facilities to the system bus 300. These memory devices 325 may include, for example, an external DVD drive or CD ROM drive, a hard drive, flash memory, a USB drive or another type of device that serves as a data storage facility. As indicated previously, these various drives and controllers are optional devices. Additionally, the memory devices 325 may be configured to include individual files for storing any software modules or programming instructions, auxiliary data, incident data, common files, or one or more databases for storing the information as discussed above.

Program instructions, software or interactive modules for performing any of the functional steps associated with the processes as described above may be stored in the ROM 310 and/or the RAM 315. Optionally, the program instructions may be stored on a tangible computer readable medium such as a compact disk, a digital disk, flash memory, a memory card, a USB drive, an optical disc storage medium and/or other recording medium.

A display interface 330 may permit information from the bus 300 to be displayed on the display 335 in audio, visual, graphic or alphanumeric format. Communication with external devices may occur using various communication ports. A communication port may be attached to a communications network, such as the Internet, a local area network or a cellular telephone data network.

The hardware may also include an interface 345 which allows for receipt of data from input devices such as a keyboard 350 or other input device 355 such as a remote control, a pointing device, a video input device and/or an audio input device.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method of generating a variable data document, the method comprising, by one or more processing devices:
identifying a variable data document template so that the variable data document template comprises one or more static element fields and one or more dynamic element fields;
for one or more of the dynamic element fields, receiving an automated personalization task, wherein the automated personalization task corresponds to one or more semantic queries for associating dynamic data with the dynamic element field, and associating the semantic queries to the dynamic element field;
identifying a set of recipients;
for each recipient, generating a personalized document template by:
adding static data to at least one of the static element fields,
identifying a set of candidate data to be populated in one or more of the dynamic element fields, and
associating a personalized reference locator at which the recipient may retrieve a personalized variable data document in accordance with the recipient's personalized template; and
when a request that includes the personalized reference locator is received from any one of the recipients, generating a personalized variable data document in accordance with the recipient's personalized document template by:
including, in at least one of the dynamic element fields, personalized data corresponding to that recipient,
for at least one of the dynamic element fields, implementing the one or more semantic queries for that field to select dynamic data from the set of candidate data for that recipient, and including indicia of the selected dynamic data in the dynamic element field.

2. The method of claim 1 further comprising, when generating the personalized document template for each recipient, by one or more of the processing devices:
identifying a data category for a first of the dynamic element fields of the recipient's personalized template; and
based on the data category, annotating the first dynamic element field with a semantic annotation that comprises a reference locator which corresponds to a content source that is semantically associated with the data category.

3. The method of claim 2, wherein the content source is also semantically associated with at least some of the personalized data for that recipient.

4. The method of claim 2, wherein the data category comprises any of the following:
a recipient name;
a geographic descriptor;
a recipient area of interest;
a mobile electronic device model identifier.

5. The method of claim 1, wherein:
generating the recipient's personalized variable data document by implementing the one or more semantic queries for the at least one dynamic element field to select dynamic data from the set of candidate data comprises, by one or more of the processors:
querying the set of candidate data using a semantic query technique to return one or more attribute-value pairs, and
using a semantic reasoning technique to identify one of the attribute-value pairs that is relevant to at least some of the personalized data for that recipient; and
including indicia of the selected dynamic data in the at least one dynamic element field comprises populating the at least one dynamic element field with data corresponding to the identified attribute-value pair.

6. The method of claim 2, wherein annotating the first dynamic element field with a semantic annotation that comprises a reference locator which corresponds to a content source that is semantically associated with the data category comprises:
selecting, from the set of candidate data, an audiovisual media asset that is semantically associated with the data category;
identifying a location of the selected audiovisual media asset; and
setting the reference locator of the semantic annotation to include a reference locator that, when selected, causes access of the selected audiovisual media asset to be served from the location.

7. The method of claim 2, wherein annotating the first dynamic element field with a semantic annotation that comprises a reference locator which corresponds to a content source that is semantically associated with the data category comprises:
selecting, from the set of candidate data, a survey or product review that is semantically associated with the data category;
identifying a location of the selected survey or product review; and
setting the reference locator of the semantic annotation to include a reference locator that, when selected, causes access of the selected survey or product review to be served from the location.

8. The method of claim 2, wherein annotating the first dynamic element field with a semantic annotation that comprises a reference locator which corresponds to a content source that is semantically associated with the data category comprises:
selecting, from the set of candidate data, a wiki or recipe that is semantically associated with the data category;
identifying a location of the selected wiki or recipe; and
setting the reference locator of the semantic annotation to include a reference locator that, when selected, causes access of the selected wiki or recipe to be served from the location.

9. A variable data document production system, comprising:
one or more processing devices, and
a non-transitory computer-readable medium containing programming instructions that, when executed, instruct one or more of the processing devices to:
identify a variable data document template so that the variable data document template comprises one or more static element fields and one or more dynamic element fields;
for one or more of the dynamic element fields, receive an automated personalization task, wherein the automated personalization task corresponds to one or more semantic queries for associating dynamic data with the dynamic element field, and associating the semantic queries to the dynamic element field;
identify a set of recipients;
for each recipient, generate a personalized template by:
adding static data to at least one of the static element fields,
identifying a set of candidate data to be populated in one or more of the dynamic element fields, and
associating a personalized reference locator at which the recipient may retrieve a personalized variable data document in accordance with the recipient's personalized template; and
when a request that includes the personalized reference locator is received from any one of the recipients, generate the recipient's personalized variable data document in accordance with the recipient's personalized template by:
including, in at least one of the dynamic element fields, personalized data corresponding to that recipient,
for one or more of the dynamic element fields, implementing the one or more rules for that field to select dynamic data from the set of candidate data for that recipient, and including indicia of the selected dynamic data in the dynamic element field.

10. The system of claim 9, wherein the programming instructions for generating the personalized template for any one of the recipients comprise instructions to:
identify a data category for a first of the dynamic element fields of the recipient's personalized template;
select a semantic annotation that corresponds to a content source that is semantically associated with the data category; and
annotate the first dynamic element field with the selected semantic annotation.

11. The system of claim 10, wherein the instructions for selecting the semantic annotation also comprise instructions to also require that the content source be semantically associated with at least some of the personalized data for that recipient.

12. The system of claim 9, wherein the programming instructions for implementing the one or more semantic queries for the at least one dynamic element field to select dynamic data from the set of candidate data comprise instructions to:
query the set of candidate data using a semantic query technique to return one or more attribute-value pairs, and
use a semantic reasoning technique to identify one of the attribute-value pairs that is relevant to at least some of the personalized data for that recipient; and
the programming instructions for including indicia of the selected dynamic data in the at least one dynamic element field comprise instructions to populate the at least one dynamic element field with data corresponding to the identified attribute-value pair.

13. The system of claim 10, wherein the programming instructions for selecting the semantic annotation and annotating the first dynamic element field with the selected semantic annotation comprise instructions to:
select, from the set of candidate data, an audiovisual media asset that is semantically associated with the data category;
identify a location of the selected audiovisual media asset; and
set the reference locator of the semantic annotation to include a reference locator that, when selected, causes access of the selected audiovisual media asset to be served from the location.

14. The system of claim 10, wherein the programming instructions for selecting the semantic annotation and annotating the first dynamic element field with the selected semantic annotation comprise instructions to:
select, from the set of candidate data, a survey or product review that is semantically associated with the data category;
identify a location of the selected survey or product review; and
set the reference locator of the semantic annotation to include a reference locator that, when selected, causes access of the selected survey or product review to be served from the location.

15. The system of claim 10, wherein the programming instructions for selecting the semantic annotation and annotating the first dynamic element field with the selected semantic annotation comprise instructions to:
select, from the set of candidate data, a wiki or recipe that is semantically associated with the data category;
identify a location of the selected wiki or recipe; and
set the reference locator of the semantic annotation to include a reference locator that, when selected, causes access of the selected wiki or recipe to be served from the location.

16. A method of generating a variable data document, the method comprising, by one or more processing devices:
identifying a variable data document template that comprises one or more static element fields and one or more dynamic element fields;
selecting a first one of the dynamic element fields, and associating a semantic query with the selected dynamic element field, wherein the semantic query defines an action for associating dynamic data with the dynamic element field;
identifying a recipient;
generating a personalized document template for the recipient by:
identifying a set of candidate data to be populated in one or more of the dynamic element fields, and
associating a personalized reference locator at which the recipient may retrieve a personalized variable data document in accordance with the recipient's personalized template; and
in response to receipt of a request that includes the personalized reference locator, generating a personalized variable data document in accordance with the personalized document template by:
implementing the semantic query to select dynamic data from the set of candidate data, and including indicia of the selected dynamic data in the selected dynamic element field.

17. The method of claim 16 further comprising, by one or more of the processing devices when generating the personalized document template:
identifying a data category; and
annotating the first dynamic element field with a semantic annotation that comprises a reference locator which corresponds to a content source that is semantically associated with the data category, at least some of the personalized data for that recipient, or both;
wherein identifying the set of candidate data comprises identifying a set of candidate data that is available at the content source.

18. The method of claim 16, wherein implementing the semantic query to select dynamic data from the set of candidate data comprises:
querying the set of candidate data using a semantic query technique to return a plurality of attribute-value pairs, and
using a semantic reasoning technique to identify one of the attribute-value pairs that is relevant to at least some of the personalized data for that recipient; and
including indicia of the selected dynamic data in the dynamic element field comprises populating the dynamic element field with data corresponding to the identified attribute-value pair.

19. The method of claim 17, wherein annotating the dynamic element field with the semantic annotation comprises:
selecting, from the set of candidate data, an asset that its semantically associated with the data category, wherein the asset comprises an audiovisual media asset, survey, product review, wiki or recipe;
identifying a location of the selected asset; and
setting the reference locator of the semantic annotation to include a reference locator that, when selected, causes access of the selected asset to be served from the location.

20. The method of claim 17, wherein annotating the dynamic element field with the semantic annotation comprises:
automatically performing a web search for a result that is relevant to the data category, at least some of the personalized data for that recipient, or both; and
setting the reference locator of the semantic annotation to include a reference locator that corresponds to the result.
